(19) United States
(12) Patent Application Publication
(10) Pub. No.: US 2024/0203284 A1
(43) Pub. Date: Jun. 20, 2024

(54) COMPUTER-IMPLEMENTED TOOLS AND TECHNIQUES USING VIRTUAL REALITY ENVIRONMENTS FOR INDUSTRIAL EQUIPMENT TRAINING

(71) Applicant: FL-Simulators, Inc., Newport Beach, CA (US)

(72) Inventor: Jelmen Lombaerts, Antwerp (BE)

(21) Appl. No.: 17/987,325

(22) Filed: Mar. 4, 2024

Related U.S. Application Data
(60) Provisional application No. 63/279,273, filed on Nov. 15, 2021.

(51) Int. Cl. G09B 9/052

(52) U.S. Cl. CPC G09B 9/052

(57) ABSTRACT

Computer-implemented tools and techniques are described for using virtual reality environments for industrial equipment training.

### CROSS-REFERENCE TO RELATED APPLICATION/PRIORITY CLAIM

The present non-provisional patent application claims the priority benefit of U.S. Provisional Patent Application Ser. No. 63/279,273, filed on Nov. 15, 2021, the entirety of which is incorporated by reference herein.

### BRIEF DESCRIPTION OF THE FIGURES

FIG. 1 illustrates one example of a Forklift Simulator sit-down model in operation.

FIG. 2 illustrates one example of a simulation graphic demonstrating an exercise objective: unloading a truck.

FIG. 3 illustrates one example of a first-person interface (HUD) of an exercise evaluation.

FIG. 4 includes a screenshot illustrating one example of a simulated forklift driving exercise showcasing the game engine's ability to simulate an oil spill.

FIG. 5 includes a diagram illustrating examples of various work packages.

FIG. 6 includes an illustration of one example of motion platform hardware applicable to certain portions of the present disclosure.

FIG. 7 includes an example of how an Octalysis framework can be integrated into the design of the simulator skill and score system.

FIG. 8 includes a combined process flow and architecture diagram illustrating various examples of software and other components which can be used in connection with various embodiments of the invention.

### DESCRIPTION

Virtual Reality simulations make up the vanguard of a revolution in learning systems worldwide. FL-simulators sells and distributes advanced forklift simulator hardware and software using Virtual Reality called ‘Forklift-Simulator’. This product allows professionals to be trained as forklift operators without needing a real forklift truck. Training on the simulator has proven to be three times as effective as opposed to training on a real truck.

Driving the simulator is a powerful computer providing a VR experience which is accurate enough to train muscle memory and depth perception. The hardware consists of a VR headset (Oculus) and a mock forklift chassis with real forklift controls sourced by forklift OEMs. At the moment there are chassis available for sit down and stand up forklift models as well as a more portable table-top mounted simulator.

FL-simulators provides services and features to empower forklift operator trainers to leverage the product most effectively too. The simulation software, which is based on the Unity game engine, provides a collection of different exercises for different skills and skill levels. FL-simulators provides associated services as well, including courses for trainers which can be organized in our own offices or on location. The simulator software is enhanced with evaluation systems providing trainers with a richer perspective of trainee performance. Other services include customization options for the virtual environments and of forklift attachments.

More trainees can get more exercise in a day using the simulator at a lower cost, but there are also other advantages. Training with the simulator is more engaging. Our trainees are rushing to the simulators during lunchtime to beat each other's records or just to have some fun. Some clients allow operators to warm up on the simulator before starting their shift, reducing accidents. Trainers are hard to find. Using simulators, a single trainer can handle more trainees. The competitive element of the simulated exercises compel trainees to try hard and beat their peers. This boosts the average performance of operators. Simulators dramatically reduce the number of hours during which real forklifts are driven by insufficiently trained operators. This decreases the probability of accidents as operators can prove themselves on the simulator first before they may operate a real forklift. Our clients have recorded between 18 and 30% reduction in incidents. The knowledge that an exercise can trivially be restarted reduces trainee stress levels greatly. Simulators can allocate more training time to build skills the trainee is lacking and less to those the trainee has already mastered.

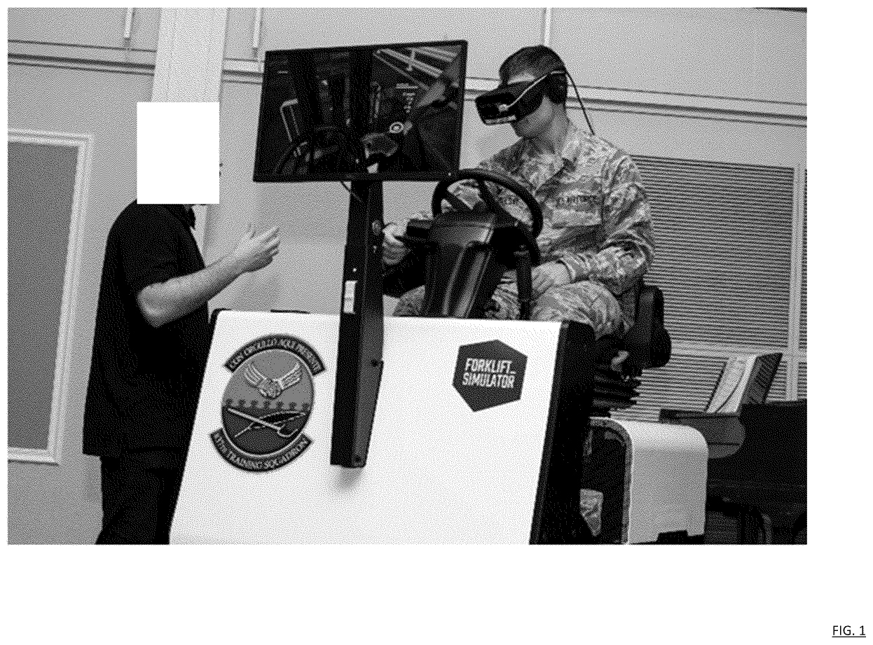

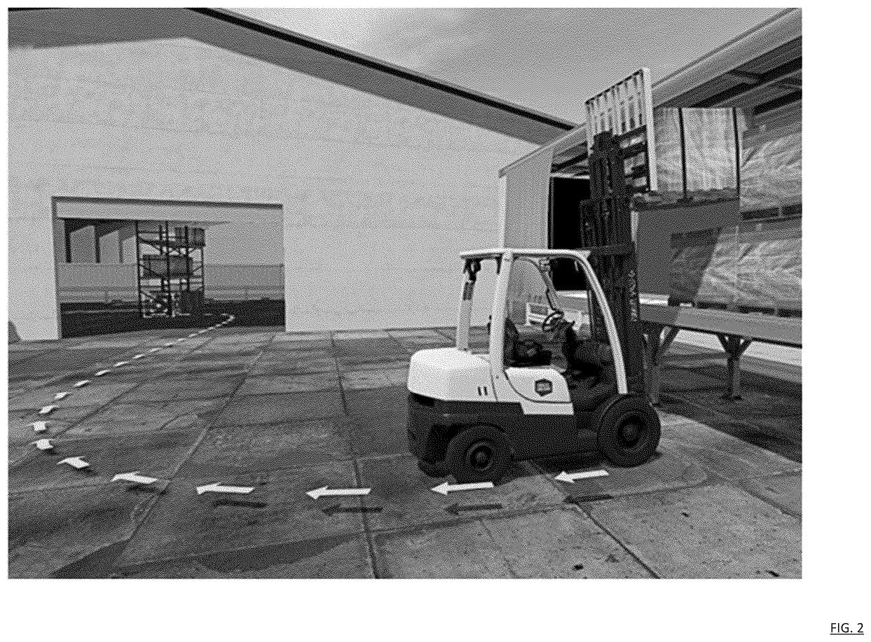

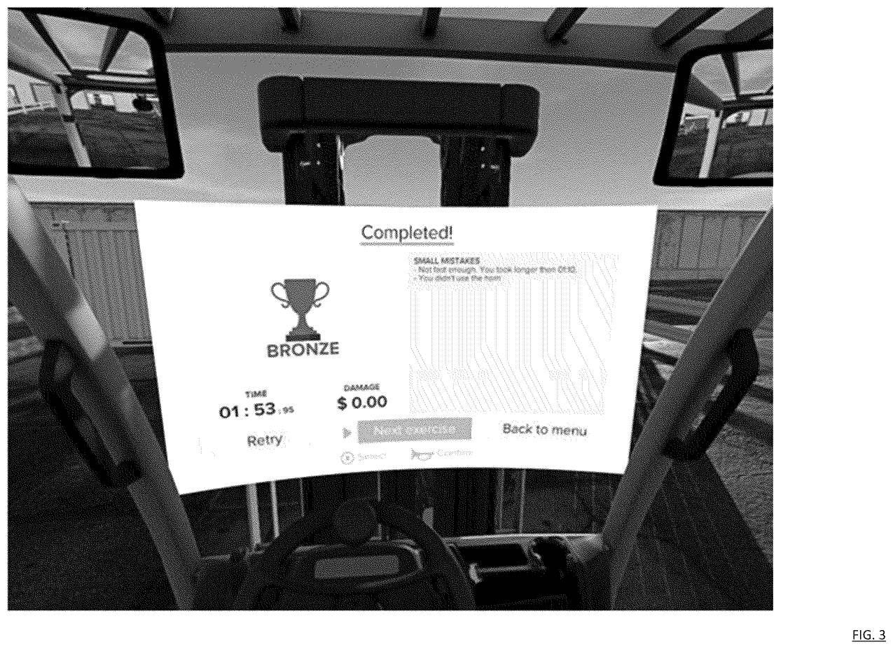

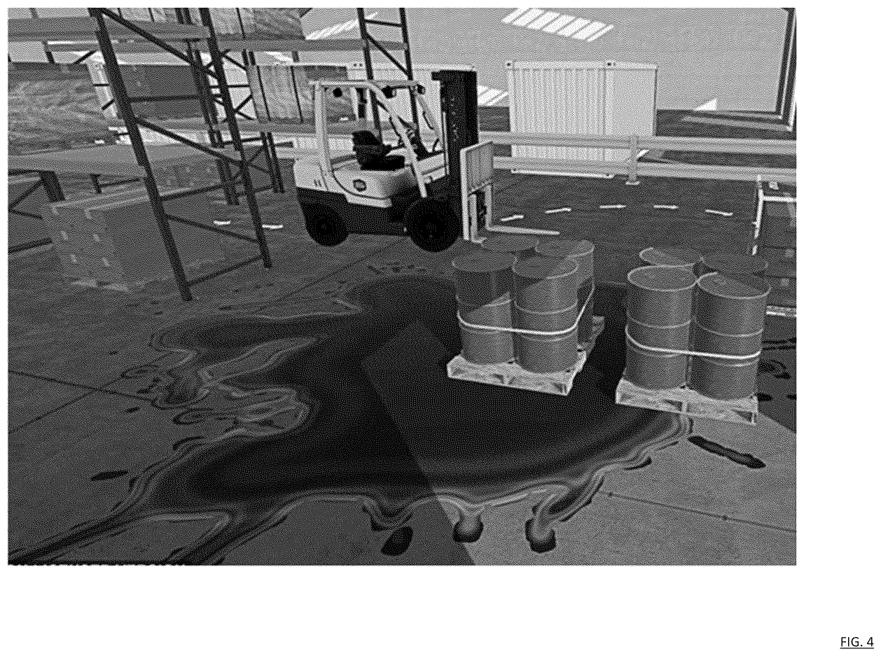

FIG. 1 illustrates one example of a Forklift Simulator sit-down model in operation. FIG. 2 illustrates one example of a simulation graphic demonstrating an exercise objective: unloading a truck. FIG. 3 illustrates one example of a first-person interface (HUD) of an exercise evaluation. FIG. 4 includes a screenshot illustrating one example of a simulated forklift driving exercise showcasing the game engine's ability to simulate an oil spill.

Trainers do not have time to create an individual curriculum for each student. Because these trainers, even the best of them, have an information bandwidth and a memory limit. Especially when they have a large group of trainees. Controlling and processing information is the reason why computers were invented in the first place. By embedding knowledge of learning psychology and gamification in our VR training service, supported by algorithmic analysis of a trainee's performance and personality in the back end, an adaptive and automated learning system can be created that gives trainers more time to coach their trainees instead of spending too much of their time on reporting.

FL-simulators can cooperate with experts in the field of education science to design an adaptive, individual and optimal tutoring system. This system can analyze trainee performance in relation to different skills as well as trainee temperament and plan exercises accordingly. It can support trainers with convenient dashboards and automated suggestions in order to maximize their efficiency. This part of PLAYWERK can be called ‘Learning Management System’ (LMS): a fusion of intelligent software and education science. Please note that our clients can be able to run in “LMS managed mode” or “Free play mode”, depending on the type of account and the settings of the organization managing the account. Free play on the simulator remains possible.

The PLAYWERK platform can also use the learning system's profiling and skills delayering systems to offer a VR training mode for new applicants. This screening and selection mode can allow our clients to preselect candidates more effectively. E.g., some people have poor depth perception and are ill suited to work as a forklift operator. This service can filter out these candidates automatically increasing hiring efficiency and safety.

Another part of this disclosure are state-of-the-art solutions to mitigate VR sickness or vection. This part of the innovation is important because in our experience clients refrain from adopting a VR-based solution due to vection issues. Reducing vection removes a major hinderance for clients as about 25 to 40% of people initially report sickness when using VR hardware.

There are no commercial solutions using VR that provide a holistic, performance oriented approach, and therein lies a significant opportunity. The competition landscape can be divided into three categories: Screen-based forklift simulators, which are or are similar to video games. VR-based forklift simulators—this category is similar to the last, but using VR goggles instead of a traditional display. They do not use real forklift controls but rely on gaming hardware. VR-based forklift simulators with real controls—our product falls in this category. Because of the real controls the product is more effective and feels less ‘toy like’ and is more suitable for adoption by professionals.

This is a list of objectives for this innovation:
An optional hardware add on can be provided which reduces vection. It can lower the number of players experiencing vection from the normal 30% to less than 5%.
The LMS system can be capable of measuring the skills of a fork lift operator to the degree experienced fork lift operators support its analysis. By definition this cannot be measured as the measurement itself is a part of the innovation.
The LMS system can be capable of modeling a trainee's performance in relation to a goal using a vector of numbers. This vector can be useable as a means of classifying trainees in performance groups (e.g., excellent, good, moderate, poor, bad).
The LMS system can be capable of working without a trainer, in principle. This means it can reliably control the VR client and a keep a trainee usefully engaged and occupied by itself. Trainer interference can be optional from a technical perspective.
PLAYWERK can run in the cloud reliably. Backups, maintenance and compute resource changes can be possible without disrupting service. PLAYWERK can have an uptime of 99.9% or better.
The LMS system can be compatible with the Experience API (xAPI) and adhere to the guidelines defined by its governing body: the Advanced Distributed Learning Initiative.
The trainers and trainees can be allowed to access a historical record of trainee performance scores.
Multiple players and trainers should be able to work together in the same virtual environment in a multiplayer arrangement. At minimum 1 trainer and 6 trainees can be supported.
Trainers should be able to interfere with trainee exercises and change the LMS configuration at runtime.
Trainees should be able to re watch replays of their important moments in both VR and by means of the web client. Per trainee at least 50 replays should be able to be supported.
The simulations in VR can include simulations real traffic of pedestrians, other trucks and AGVs (automatically guided vehicles). The system should be able to support 20 NPCs (non-playable characters) at minimum, even in multiplayer.
The simulator VR client can provide a mode in which the player is placed in a single testing environment where the LMS system can assess the trainee's skills in less than 20 minutes. The score can be sufficient to allow for pre selection. Especially for depth perception.
On average a trainee can have a 45% higher chance of succeeding the assessment after having been preselected by the LMS HR system compared to a non-preselected trainee.

Expected knowledge build-up—there are three major fields FL-simulators can build new knowledge: learning systems understanding and development: large scale centralized web platform development: and vection mitigation and the effect of VR on the human brain. Knowledge can be acquired through collaboration with experienced professionals in the professional training/education field. FL-simulators can understand the difference between good and bad trainers and their methods. We can understand exactly why good trainers get better results. FL-simulators can engage the right people, some of which have experience in developing such large scale custom web applications. The game specialists and web specialists can collaborate together and implement the domain knowledge from the field of learning psychology into the applications with our guidance. The knowledge build-up can be both technical (technology, programming language and tools) and practical (cloud provider requirements, redundancy, security and safety).

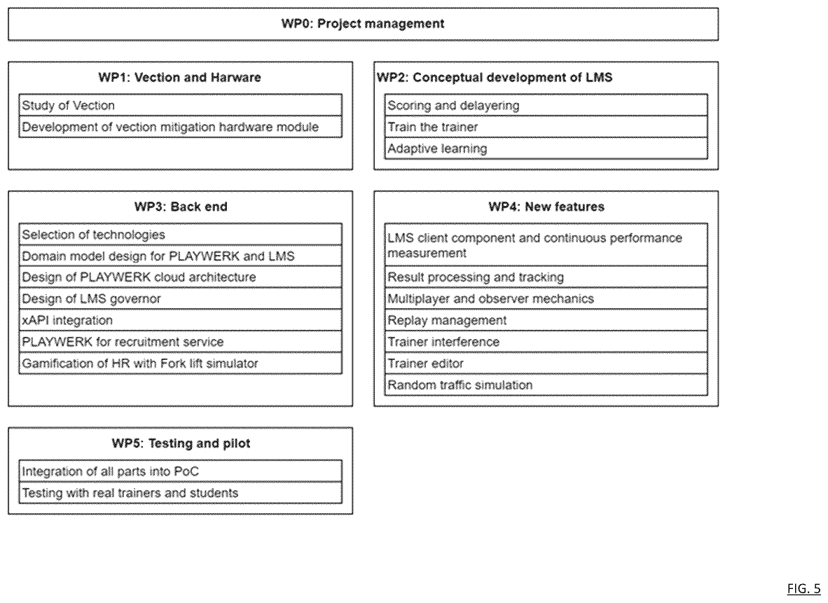

Work package 1 (“WP1”) gathers all hardware related efforts with an emphasis on practical study. Vection related work and the development of the hardware part are topics of this WP. WP2 is the work package in which the advice of external education experts can be used in order to make a novel VR education system. Its result can be used for other developments but especially WP3 and 4. WP3 is about building the back-end part of the project on which PLAYWERK is based. It includes the development and setup of the cloud architecture and the translation of the conceptual system of WP2 into operation. This means all LMS related processing (e.g., score calculation) can be centralized in back-end services. In this task a library can be developed for LMS which can be embedded into the game client too. WP4 is about the Unity (VR) part of the project. It starts in parallel with WP3 because it's about different technologies and different applications in the beginning. Eventually WP4 can use the libraries developed in WP3, as they can be developed in parallel. By consequence the work in WP4 is similar to game development. Some work is also related to the web client, but the vast majority of the front-end work can be done during the engineering stage. WP5 is a synthesis, integration and pilot package. This is crucial to make sure PLAYWERK is made whole and consistent as well as validated and tested so that the development can be corrected and adjusted where necessary, before entering the engineering stage after this development project to prepare PLAYWERK for commercialization. FIG. 5 includes a diagram illustrating examples of these various work packages.

It is important to understand as much as possible how vection is caused and how many people are affected. These are questions which can be answered. Vection is an old problem of the industry which many businesses have tried and failed to solve. Or at least they did not succeed without using prohibitively expensive hardware. Vection is a major hindrance to VR adoption by clients. The reason why FL-simulators expects to be able to solve this problem is because forklift trucks exhibit a relatively limited range of motions compared to other simulated vehicles. Most of the motions consist of rotations (mostly yaw), which are less complex to replicate. Because of this we expect that we can get the same results with a simpler motion platform which were usually only obtainable using an expensive Steward motion platform. We can look into these questions first in order to understand vection at the fundamental level: How long does it take for vection to occur (statistical distribution)? In which way does the VR experience affect vection? More specifically, in which situations does vection occur in Virtual Reality (e.g., VR character in moving vehicle versus VR character stationary)? Which situations allow the player to ‘cool down’, if applicable? Which situations have to be limited in duration to prevent vection to ‘build up’, if applicable? Which process causes vection in the brain? How can physically moving the player in reality lessen the vection effect? The second activity in this task is to use the current game client to try and induce vection in order to validate the hypotheses resulting from the investigations in the first activity.

The goal of this task is to develop an understanding of vection so subsequent development can be oriented effectively. It is a new type of development for us because it relies on user accounts of feelings. Because this development measures aspects which are difficult to quantify, it can rely heavily on statistics. In that respect it definitely also has biomedical aspects, which is a first for FL-simulators.

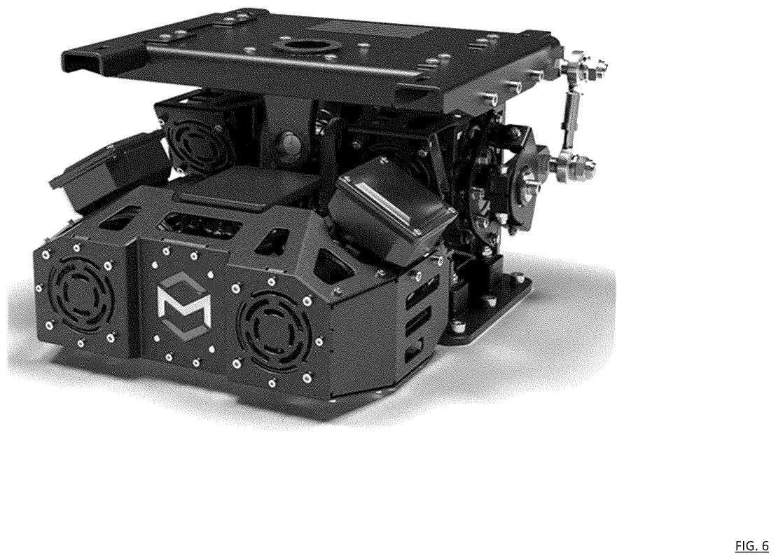

Development of vection mitigation hardware module. We have found a manufacturer, Motion Systems EU, who develops motion platforms for different user applications. This company just launched a small hardware set up which can be investigated in this task. This hardware is very interesting because it is more cost effective compared to Steward platforms. The spectrum of motions it can replicate is limited, but overlaps significantly with the range of motions a real forklift exerts on its driver. While this is being investigated further market research can be conducted to uncover alternative and comparable solutions from other manufacturers if possible, and when needed as backup. Selecting the motion platform is the first part of this task. FIG. 6 includes an illustration of one example of motion platform hardware applicable to certain portions of the present disclosure.

The second part of this task is acquiring the chosen motion platform, connecting it to our simulator. Changes to be made to the hardware can take place at this time. The hardware changes are finished when the platform connects reliably to the simulator computer and is capable of running within the required operating parameters.

The next activity is the development of the control mechanism by experimentation and analysis. The nature of the experiment is adding control code to our simulator application to control the motion platform using a specific transformation of the velocities and accelerations of the player object in the simulation. When the experimental hardware is up and running, people who are sensitive to vection are to be tested with it and the results registered. The transformation function needs to be tweaked until the results cannot improve further or vection has been eliminated according to the test subjects.

The end result of this task is a suitable motion platform who has been proven to eliminate, or at least substantially alleviate, vection in the test subjects. It is acceptable for the solution not to work on all test subjects, but it needs to help more than 90% of people affected by vection. In the engineering phase after this innovation project the prototype can be further elaborated into a commercial product, which can be offered as an optional extra for simulator clients.

FL-simulators has experience with masses of trainees learning to operate forklifts. In this task FL-simulators can use this experience to develop the conceptual basis for a skill-focused learning method, which can be designed in opposition to the usual, mistake-based, learning of less sophisticated methods. It should also be noted that FL-simulators cannot adopt an existing framework because digital tutoring systems for VR are very new. Competing VR solutions, in so far they exist, do not yet share their technology. The foundation of our pioneering system can be the ‘delayering’ of skills and calculating truly informative scores from exercises, backed by education specialists. The term ‘FL-simulators skill and score’ can be used to refer to the set of delayering techniques, skill descriptions and score calculation functions.

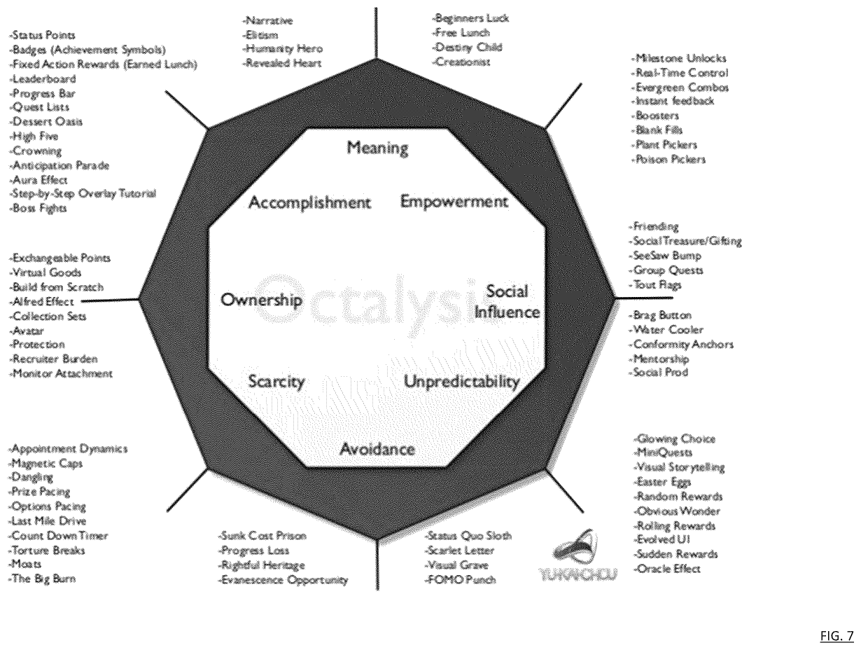

Drawing inspiration from the collected information. The Octalysis framework (see FIG. 7) can be integrated into the design of the new FL-simulators skill and score system. Frameworks are a set of interrelated objects, physical or virtual, which can be recombined in effective ways in order to produce higher order structure more efficiently. The framework comprises a collection of measurement techniques and formulas to help develop ideally engaging skills based exercises and a curriculum for all personality types. Software frameworks, used in other parts of this document, are a collection of objects and functions to build software applications more effectively. The framework can be modified to suit the VR experience before it is implemented. The advantage of the Octalysis framework is that it can take the individual trainee's personality into account and as such leverage the trainees intrinsic motivation. The disadvantage might be that this framework is geared too much towards entertainment and is difficult to translate to specific skills related to fork lift operation. It is nice if Fork lift simulator can be made to be entertaining, but it is mostly meant to become a performance oriented, result driven, enterprise asset. This is why it was decided to introduce an opposing philosophy.

The Octalysis framework can be integrated into a 4C/ID model of task based curriculum. Strategies can be selected in order to make an interesting mix of more motivation based (computer game derived) and more result driven (institution derived) knowledge. The important part is that both approaches have a focus on skill, which is key to any modern education paradigm. The result of this approach is an unambiguous conceptual description of how to measure skills and how to design exercises to develop skills. This hybridization of paradigms makes this research unique and pioneering.

The next part is to combine the methodology of measuring skills and develop a multidimensional scoring system and the algorithms to calculate a score. This scoring system can be used in the LMS and in future HR oriented service offerings by FL-Simulators. It should be noted that this scoring system, by necessity, needs to be custom designed for the new paradigm developed in this task and therefore cannot be copied from an existing solution. The fork lift training is simply too specific in nature. At the later stage the scoring system can use the score vector to determine the next exercises and the HR analysis service can use it to match applicants with occupations. The result of this task is a description of a scoring system consisting of a description of its dimensions and a calculation algorithm. Mathematical descriptions to calculate single-number performance indicators, including an ‘overall grade’ from the multidimensional score, are also a part of this description. Many digital tutoring systems fail to accurately determine the real level of challenge a student needs, making the student either bored or overwhelmed. Most tutoring systems feel overbearing and/or too constricting. It is a real challenge to design a system which is both effective and accepted by students and trainers at the same time.

This task is about expanding the FL-simulators education concept to include trainers. FL-simulators has experienced at first hand the importance of good trainers because it can be clearly identified that the trainer is an important asset to ensure a good outcome for all trainees in the class. The more intelligent way to proceed is to assist trainers in order to make them more time efficient and effective as well as improving their working experience. This task has two main activities. The first of which is the development of the ‘train-the-trainer’ program. For the first activity a specialist can integrate TTT's knowledge with the experience of FL-simulators and the FL-simulators skill and score system designed herein. The end result is a complete description of the train the trainer program. The second activity is the further improvement of the FL-simulators' skill and score system by expanding it with descriptions of control mechanisms for trainers to control the automated systems which optimize an individual trainee's curriculum.

Also, the findings of the first activity can have yielded descriptions in which ways trainers would ideally like to influence exercises of their trainees. Trainers should be able to correct to automated skill delayering and score systems. The description of the FL-simulators' education concept can be expanded with formal descriptions of the methods trainers can use to affect it. Most of the concepts defined earlier can receive updates. Next, a final synthesis of the train-the-trainer program can be performed to incorporate the latest insights. This reflects the fact that all design activity is iterative and all insight is progressive. The end result is a revised FL-simulators skill and score system, published in digital form with a complete list of concepts, a collection of diagrams, and very detailed definitions. The skill and score system can eventually be implemented into the system. The FL-simulators skill and score reference can be used as a primer for any software developer.

The focus on trainers is an extra design requirement many competing systems have not been able to include during their development, making this work unique in the world as far as we know. This is because it is easier to focus on the students exclusively and to arrogantly assume they can behave predictably and according to the model at all times. With this task FL-simulators accepts that students are more complex than any model could predict and makes the effort to make the system transparent to trainers so they can be assisted by it instead of the other way around. The extra challenge this poses is caused by the fact that an additional and completely different type of user needs to be catered for.

The system can include an adaptive learning system specifically geared towards VR training. This system is to be developed with Athru, because they have experience in game manufacturing. It is to use the scoring component of the FL-simulators skill and score system in order to automatically determine the next exercise for a trainee in an ideal way. Because of the insights gained, the system can be able to process and react to trainer input. Adaptive learning can be a part of the LMS system. This task is a synthesis and consolidation of this work package.

It is expected that many new concepts can be designed such as exercises, performance levels, skills graphs, score evolution models and more in order to be able to describe an individual trainee's dynamic curriculum, his or her evolution, the educational goal and more. For example, an occupation (job) might be considered as a multidimensional half-plane in the multi-dimensional score space mathematically. The description of a curriculum is a ‘journey’ in this score space and in a skills graph (a graph in which the nodes represent mastery of skills and the edges represent exercises). The involvement of a software developer can make sure the concepts can be modelled later. The developer can be crucial to make suggestions during the meetings as well. In some cases, it may not be clear which choice to make on the conceptual level of analyses. When that happens the developer can formulate the design constraints for implementation which can help the designers to make the decision which is easiest to implement later.

The new system can control trainees' learning progress and can contain APIs for the game client to access in order to show scores, know the next exercise and many more things. Unlike before, FL-simulators can require a custom designed ‘back-end’ for the first time. Trainers and trainees may not always have access to the VR environment but can need another way to check their progress, control the system, edit their profiles, and more. For this FL-simulators can need a web client (web application) to complement the game client, which can be accessible using a browser (or Electron desktop app) and only require a login. Before the development of this back end and front end may begin, the team needs to understand and analyze the requirements, and decide on how to proceed. This is a list of what can be decided in this task: programming language(s): web framework: database storage paradigm (Relational or document bases) and database technology: machine learning framework to facilitate neural network enhanced processing of multidimensional scores, personality types and other complex models; hosting requirements for cloud provider or infrastructure: testing frameworks and the organization of end-to-end testing: communication protocol between the game client and the service: technology for web client, which can be a web application: and, ORM, dependency injection, mathematical libraries and other support systems for both back-end services and front-end web application. These choices concern completely new technologies for our developers, especially cutting edge machine learning frameworks, real time rendering and non-standard communication protocols. Other choices are also challenging because they impact a large set of interrelated systems.

The first part of this task is to develop the PLAYWERK domain objects and associated systems for storage (database) and communications (application level protocol transport objects). Domain objects include trainees, trainers, managers, accounts, client companies, game sessions and so on. These objects can be used in any service which needs to work and reason in the general context of PLAYWERK. For example, any service performing meaningful work can have a reference to a ‘user’ to check permissions or to an ‘account’ for billing. All of these objects can be packaged in a library, which can be referenced by future services. The library can be expanded with unit tests in order to ensure the quality of the procedures in it. A test application can be built around this library which can be capable of connecting to the database in order to fetch and store object (e.g., users, accounts, . . . ). This application can be equipped with a CLI (command line interface) in order to invoke procedures in the library separate from logic in other applications. Some of the procedures can automate database maintenance, backups or other convenience features to be defined. This application can remain useful as the development progresses and during commercial operation afterwards.

The FL-simulators' learning concept and the adaptive learning concepts can be translated into a single library of programmed objects and procedures referred to as the LMS library. The development of this library is the second part of this task, because this library can refer to the first PLAYWERK domain model and build on it.

With references to the PLAYWERK domain objects the programmers can translate the concepts designed in WP2 into programming code. Skills, scores, skill graphs, education goals, score histories, and curricula can all be translated into a structure of programmed objects which are correlated with each other. LMS concepts may refer to PLAYWERK concepts, but never in reverse. The application level communication protocol for the LMS, which can consist of serialized data objects, can also be developed in this task to facilitate communication between clients (web and VR) and services such as the LMS governor (task 3.4) and PLAYWERK HR services. The end result of the second part of this task is a software library which can be integrated in other services. One goal of this task is to develop two domain models describing PLAYWERK objects and LMS related objects. The PLAYWERK library can have an accompanying and integrating test application for testing and supporting database maintenance.

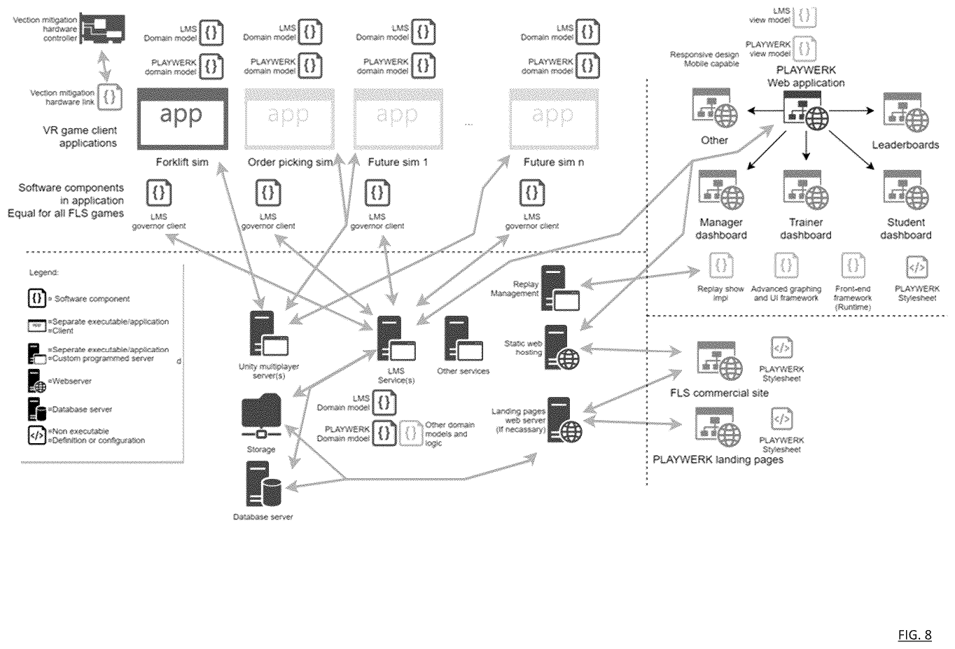

FIG. 8 is an approximate representation of how one example of the total application architecture looks, the individual software components in the diagram, and the design of the structure these components operate in. This task is about defining the environment and configuring the resources needed to run PLAYWERK. The infrastructure can be provided by a cloud provider (e.g., Amazon AWS, Microsoft Azure, Digital Ocean, Google Cloud, IBM cloud, . . . ), which can be configured completely in this task. The services can have some dependencies on other systems in order to be able to run (e.g., Python interpreter for Python or a JVM for Java). Resources can be configured for the components first: domain and routing: TLS certificates for secure communications: deployment of services on compute resources using docker containers if necessary, deployment can be VMS, orchestration services or FaaS: static file management and static file web hosting: and database(s).

In a next step the cloud provider can be configured so all services can reach each other and can be reached from the outside. There are numerous other concerns: backups, scaling of services, load balancing, secure communications, error recovery, and logging. The web infrastructure can be a single WordPress website. Another challenge is to provide a machine to run a unity server instance for the multiplayer functionality. In order to provide the correct environment FL-simulators can apply the game engine manufacturer's (Unity) recommendations and map them to available cloud provider configurations. The final part of this task is to make sure all developers can easily upload their code to the cloud provider and test it. Their tools (Integrated Development Environments (IDE)) and toolchains (language dependent) can be integrated with the cloud provider to increase efficiency. The end goal of this task is a configured cloud provider on which PLAYWERK services can be deployed both in the development, testing and commercial phases of the software development. All applications can be able to use the database and a file system, and can have the compute resources to run as well.

The LMS governor service, which is an implementation of the adaptive learning system, is the first service to be developed and deployed. It constitutes the core of the innovative adaptive learning system and the first functional PLAYWERK service. Every service can expose an API which is a catalogue of functions for clients, which can be VR applications or web applications.

The VR game client can be updated to react to the type of account logging in. If the account belongs to a trainee enrolled in an education program defined by the corporate client then the game client may be able to be controlled by the LMS governor service. This service can be developed in this task according to the standards defined in task WP2 and for this it can utilize the PLAYWERK domain model and procedures library, and the LMS domain model and procedures library.

The game client may be able to request the LMS governor to send it the next exercise through API functions to be developed here. Because the service can contain an implementation of the learning concept and adaptive learning, it can be able to take the specific skill set of the trainee into account and determine the exercise the trainee needs in order to move him or her through the skills graph towards the intended goal. The procedures of the LMS library can be able to model trainee skills, calculate scores and determine the next path through the skills graph. The ‘exercise query’ function is the first functionality to be developed in this task.

Next, the LMS governor can be designed in such a way to expect a result after the exercise containing a record of the trainee's performance though its API functions. After this the service can update its understanding of the current trainee and its total evaluation. The LMS governor can maintain records of each trainee and store them in the database. Trainers can access these records in order to coach more effectively and augment the system's evaluation. Trainees can also be able to view a subset of this data, which can look like an interactive score card. This can improve trainee self-awareness and foster healthy competition between trainees who are inclined to do to so. The LMS governor service can also offer API functions to allow trainers to alter its state by using the trainer specific web application. E.g., the service can expose a function in which the trainer can tweak the trainee's personality level in terms of competitiveness.

The result of this task is a first functional prototype of the LMS governor with all communication structures in place and properly deployed. It can be tested using a command line interface. It can be updated later as the game client is adapted to it. The runtime, communication paradigm (HTTP, stateful or REST, etc.) and the way in which the service connects to the database can also be a template for future services.

The experience API (xAPI) is an open source e-learning software specification for tracking and describing learning experiences, results and progress. The xAPI specification serves as a standard for ‘distributed learning’ which means it establishes a data and communications standard for interoperability between different education systems as well. xAPI makes it possible to track trainees as they navigate through multiple sources of instruction by a higher order application (please see the xAPI documentation for a list of all instruction sources). FL-simulators wishes to integrate with this system so our VR simulator exercises can be integrated in external electronic education programs.

The first activity can expand the domain model with other objects, which can be built according to the xAPI specification. ADL, the organization responsible for xAPI, has public code repositories containing their data objects but only in the Java language. So, FL-simulators can translate this public code into our own programming language first. These new objects can be added to the LMS learning library. xAPI, as stated before, lies only at the boundary between systems. So, when the objects have been translated, integration with the existing objects can be performed. Also, any computational procedure explained in xAPI which is not specific can be coded in this library as well. The most difficult parts of this work are the xAPI objects which need to be mapped on the already developed LMS objects and the mapping functions.

The second activity in this task is to expand the LMS governor service with methods to make it compatible with other learning systems. The VR game client, when in the required operating mode, is completely controlled by the LMS governor, responsible for tracking performance. This is why the LMS governor can be equipped with the xAPI communication standard. The work in the second activity can consist of following the xAPI specification further and implementing all the required communication functions into the LMS governor. This work is challenging because xAPI itself is a complex and comprehensive specification. The LMS is also quite complex. Integrating a VR training exercise into a combined higher order education curriculum is challenging because xAPI was not really designed for VR exercises.

The system can make VR simulations usable for selecting and recruiting candidates. It can rely on the LMS capability to detect skill and to identify weaknesses. Like most PLAYWERK services it can import the LMS library. A matching VR game mode can be provided to use this service. When a trainee is enrolled in an externally mandated curriculum, the VR client can be controlled using the LMS governor. Similarly, when the trainee's account was registered as a ‘screening type account’ it means the trainee is not (yet) enrolled in a curriculum but needs to be tested and its VR client needs to be controlled by the ‘Skill screening service’ to be developed in this task. The ‘screening service’ can set up an appropriate exercise regarding appropriate parameters. These parameters can be defined at the time of development by consulting with our HR domain experts. In any case the service can receive the desired score area (derived from the target occupation or job) as a parameter so it knows which skills to test for (e.g., what level of depth perception is required). As the trainee is performing the exercise the performance measurement can work as normal. After the exercise the recruiting screening service can process the results and produce a report assessing the trainee's skills and suitability to the job. The output of the service can be used by a web application developed separately for HR selection and screening purposes.

Some of the methods developed for the LMS governor are taken over and updated, but others can be redesigned for HR purposes in this task. The challenge for this task in linked to the translation of the business of the HR companies into the LMS evaluation systems. Human applicants are complex to understand. In normal curricula a record of multiple exercises is built by the system so there is sufficient time to make this model as correct as possible. In this case the HR service is designed to screen quickly and this could mean the LMS does not really get enough time to converge.

LMS client component and continuous performance measurement. The LMS governor is the back-end implementation of the LMS. The game client also needs a part of the software to monitor the exercise as it progresses. This task is about the development of a specific new part to be implemented in the VR game client which imports the LMS library developed in WP3. This part, also called component, can incorporate an HTTP client, which can communicate with the LMS governor.

This new component can set up the next exercise according to the specifications from the LMS governor, and it can report back the results after the exercise. Programming this functionality is the first part of this task. A function needs to be programmed that selects an environment and configures it according to the server's instruction. Especially tweaking the level of difficulty is important. A set of configurable training environments for forklifts can have been prepared, taken over from the current version of forklift simulator or new ones developed separately. These environments facilitate all kinds of exercises and each can have been annotated with metadata for the new component to use. During this task the metadata of these environments can be tweaked and optimized as well. The environment can be designed in such a way that it allows for multiple trainees to operate in the same area.

The second part of this task is to program another component in the VR client that continuously measures performance according to the theory researched and documented in WP1. Examples of this are the number of jerky movements, the number or near collisions and collisions, the level of mechanical sympathy of the driver. This work can consist of mathematical functions using game engine data as a source. The challenge in in this task can mostly be associated with the translation of the theory of WP2 into mathematical functions. Changing the level of difficulty is a matter of tuning the experience carefully. Some performance measurements are more difficult to measure then others, which is yet another quantification problem. For example, counting collisions is easy, but detecting a ‘near collision’ is much more difficult.

The end result is an updated version of the fork lift simulator VR client which is capable of connecting to the LMS governor after the trainee has logged in. It can be capable to setting up exercises according to the directions of the LMS service and report the performance of the trainee. It can also be capable of recording some performance aspects in real time during the exercise and send this to the LMS service.

Result processing and tracking. This task is about the development of a processing system of trainee performance with a visual component on the web. In WP2 it is shown that the skills and scores are complex things to appreciate. It is from this complexity the new system draws its power of expression. The PLAYWERK web application can show a more traditional dashboard with trainee performance data, the actual development of which is not a part of this innovation project. In this task the performance tracking and analysis service is developed which uses the LMS data as an input. The visualization aspect can be developed conceptually. It can be noted that this system is different from the one 4.1 as well.

In this task, there is a graphical way to present a trainee's performance to a trainer, so the trainer can quickly decide which intervention is necessary. For example, when the trainer is considering a group of trainees, he or she should have a means to select a specific trainee and see quickly where a trainee is still having difficulties in order to provide the best coaching. For example, if a trainer sees a trainee struggling with acquiring a certain skill then he or she may change the curriculum.

The visual aid can be able to show trainee performance at that moment (the last exercise), but the back-end system can also generate different views of the trainee's historical performance. The trainer can be able to call historical data from the database and review the trainee's progression over time using the web application. This means trainers can have at least two trainee views: recent performance and historical evolution. The challenge is that there is a very large volume of data logged for each trainee. The visual aids may not show too much information at one time. So, the system can decide intelligently which performance indicators are important and need to be shown. Another challenge is making a useful historical record from the LMS output.

Multiplayer and observer mechanics. The Unity game engine, on which the VR simulator client is based, provides some means to set up multiplayer sessions. Nevertheless, each Unity application does need a custom solution for multi-user operation because its standard library only offers helper objects and procedures, not complete solutions. This is also the first time FL-simulators can incorporate real-time connectivity between VR applications. Because of the real time requirement, this is one of the most performance-critical parts of the new VR application. The system upgrades the offline client into an online client so sessions with multiple trainees in one environment can be technically possible.

The first activity can be to set up this unity multiplayer service by developing a new server by making use of the Unity library and FL-simulators own developments. The next activity is the adaptation of the VR client. This includes updating the code to be able to set up sessions with multiple “players” (from the game engine perspective). This activity can conclude by testing a playable session with just forklifts. Further changes can be adapted to allow “trainees” and “trainers” to enter the exercises. This includes special forklift experience for trainers, when they choose to be physically present in the simulation, or a non-physical observer type of experience for when they do not.

A test session can be provided in which multiple forklifts and a trainer can run in the same environment. The challenge of this task is associated with the general difficulty related to network connected multiplayer games and the fact that each multi user solution is different, even when the same real time technology is used. The biggest challenge is related to game stability. Systems like these are completely intolerant to any object state getting ‘out of sync’ so they need to be designed in an almost mathematically rigorous way.

Replay management. Another part of the new PLAYWERK system is the capability for trainees to learn from their mistakes. In order to help the game client can be capable of capturing a part of the action when the LMS system signals an error, or when a sharp decrease in performance is occurring. The unity game engine has functionality to capture game states or video for replaying game action. The goal of this task is to extend the game client with a system that continuously records the actions. As soon as the LMS raises an event signaling something significant has happened, this system can save the last minute (or more) of recording to the hard drive. The drive can only act as a buffer because a parallel component can gradually upload these recorded replays to a service in the cloud. This back-end service accepts a file with context data and store it correctly. In this task the focus is on the new part of the VR client that actually captures these replays in real time, buffers it on a local drive and sends it over network. Trainees can be able to replay the recordings eventually to learn from their mistakes using the PLAYWERK web client or the VR client.

The challenges in this task are connected to the ‘nature’ of Unity's recording capabilities. If the replay is recorded as a video, then processing it is easy, and it can be viewed in the browser directly. The downside is that this video is two dimensional and it cannot be replayed in VR. If Unity saves replays as a series of game state objects (which is far more likely) then the only type of application capable of replaying is a unity application with access to the same assets, in this case the same VR client. The advantage is that the user can review the action in 3D. For this offline rendering, FL-simulators a back-end service derived from of a Unity instance can be used from the original forklift simulator. This service can continuously set environments, replay the replays and record a video using an external video recorder.

Multiple players can be able to do exercises in the same environment (this cannot complicate the working of the LMS system as long as exercises from multiple trainees do not interfere practically). Trainers can be able to join in two ways: forklift mode—the trainer is present in the simulation in a fork lift together with the trainees: and god mode—the trainer is an all-seeing observer with a different non-forklift physical model in the game. The part of the new game client can be developed that can provide the trainers with capabilities to interfere with exercises and to support trainees. Examples of interference can be resetting a fallen object, making exercises harder or easier, moving a forklift a little, resetting an exercise, triggering a replay save, and/or taking a player back in time.

The challenge in this task is to handle the discontinuities a trainer might introduce because of his actions. For example, if a trainer resets a trainee's position, how can this affect the performance measurement? Also, trainers may need a more advanced HUD (Head-Up Display), which can allow them to have an overview of how all trainees are doing and have a detailed view of a single trainee.

Another task is about the development of another extension to the game client, this time for trainers. The trainer editor is a specific state of the game, only accessible to trainers, in which the trainer can change the environment for each exercise or even design its own custom exercises. It can be accessible if the trainer logs into his account. The challenge is that normally exercises are developed at design time with the tools like Unity editor available to developers. In the present system, editors and developers can program a means to change the environment in the game client itself. This means trainers can have an HUD menu to choose environment elements from, and a means to place them in the environment. This “editing” is a balance between complexity of use and power of expression. If trainers can change too much, exercise editing may become too difficult and/or the VR client unstable. On the other hand, if trainers are too limited, the feature becomes useless.

Besides changing the environment, the trainers can alter or define the exercise objectives, which are abstract. Developers can find a way to visually represent performance goals, exercise objectives, trigger mechanisms and other things. It is also possible the trainers can provide extra definitions (and meta data) in order to help the LMS incorporate the custom exercise in a curriculum. The basic idea behind the LMS is exactly the opposite of an old fashioned, linear cascade of exercises. Even the custom exercises can be understood by LMS.

Random traffic simulation. This task is another extension of the game client. But in this case if can be relevant to all participants. In a real factory there is constant traffic of pedestrians (sometimes even cyclists), other forklifts and AGVs (automatically guided vehicles). In this task the system can be developed to simulate this traffic in VR. The system can define all types of traffic and make an autonomous controller for each of them, accurately simulating all movements. ‘Helper objects’ can be defined, which developers can enrich the environment with to give the autonomous agents a hint. E.g., a graph defining footpaths for pedestrians, another for non-player forklifts, a set of objects to have non-forklift players interact with. The challenge of this task is the development of the autonomous controller. A too simple implementation can break the illusion of realism very quickly, but a freer controller may lead to unpredictable behavior which could even interfere with fair evaluation. At the end of this task all exercise environments can feel real, with realistic traffic. The amount of traffic may be determined by the level of difficulty defined the LMS. The last part of this task is refreshing the trainer editor so trainers can also control the traffic in terms of locations and frequency.

Gamification of HR with forklift simulator. The system can provide a modified version of the forklift simulator (or perhaps a different ‘game mode’ if that is more convenient) exclusively geared toward HR selection). A back-end service has been developed in order to use the LMS scoring system for HR profiling purposes. This task is effectively the creation of a front end for this system in VR. The forklift simulator can be used as an effective tool to quickly assess whether a trainee has the basic skills to become a fork lift operator. This feature is valuable for choosing candidates more effectively. It makes more sense to hire a person who already possesses excellent driving skills and good depth perception, even before the training starts. The technical difficulty in this task is to make the system assess a set of skills in a single exercise and in as little time as possible. This makes this ‘exercise’ the complete opposite compared to any in the normal curriculum where there is plenty of opportunity for repetition, but for HR screening there is not as much time to evaluate the student.

The system can provide a version of the VR client (or game mode) that does not require the trainee to log in (or use a guest account). A default series of exercises, or a single combination exercise, can be presented to the trainee according to the guidance of the back-end HR selection service (task 3.6). Developing such an exercise and determining the minimal time and thresholds the system needs to correctly assess most students is a major challenge in this development. Another difficulty in this task is associated with the fact that a short exposure to VR is a very different experience to a gradual introduction with plenty of instructions. In order not to be too hard on the applicants, simpler and more beginner friendly, exercises can have to be designed in order not to over-stress candidates. The development of these simple exercises is difficult because despite their simplicity they can provide sufficient feedback data to the LMS system in order to calculate a representative result.

Visual Method in Virtual Environments to Reduce Simulation Sickness. It has been well understood since the advent of virtual reality vehicle simulators, such as flight simulators or vehicle racing simulators, that approximately 30% of users can experience discomfort akin to motion sickness when exposed to movement in a virtual space. The underlying reasons for this are not yet well understood, but for many the discrepancy between the sensation of movement without actual movement can cause these conditions to occur. Best practices for this issue involve adding a motion platform to the simulation that moves the user in ways consistent with the motion they perceive in simulation. For example, the simulator sits on a motion platform, and when the user drives forward the platform leans the user backward so they get the sensation of acceleration of the simulated vehicle. It's generally understood that usage of a motion platform can reduce the sensation of vection that leads to motion sickness to rates approximating 10% or less of users.

Vection is a sensation created when a large part of the visual field moves, a viewer feels like he has moved and that the world is stationary. If this sensation is prolonged it can lead to motion sickness in susceptible individuals. The challenge with these motion platforms is that they are expensive, adding thousands of dollars to the cost of the simulator.

Another method to reduce the sensation vection that leads to motion sickness is to limit the field of view of the user while they are in motion. An example would be to simulate tunnel vision while the user is moving, then restore peripheral visual information gradually as the user slows down, fully restoring it when they come to a complete stop. This method can be somewhat effective for some users, but the effect is disconcerting, and itself can cause discomfort in the virtual environment because it is not something that the user has any natural experience with. If it weren't for the sensation of vection, the best user experience in simulation is as close to reality as possible.

In professional training applications, such as flight simulation or heavy equipment simulation, these effects can be even more problematic. It is difficult to compel professionals that are required to experience simulation in order to aid in training for their job function to repeatedly expose themselves to an experience that can cause such discomfort. The more comfortable the user is in simulation the better compliance rate are with training.

The nature of the present disclosure is a visualization mode that helps solve this problem. In this implementation, used for situation in which the user can move in virtual reality, the user is placed into a virtual environment that is much more soothing and static, and they experience the simulation through simulated television screens or windows. The user is in a scene, such as a classroom or office, and placed with television screens around them. The television screens show the actual simulation screen, such as the world around an airplane in flight, or a warehouse around a forklift simulator. As they move in the virtual environment, this movement is only reflected in the screens around them. In essence, the system is simulating in virtual reality those simulators that existed before VR was a commercial option.

Comfort can be further improved if the scene on the television screens/windows lacks 3D information. That the image sent to each eye in the goggles is the same. This way, the view through the portal is flat. This lack of depth further decreases the amount of immersion, and the impact that motion has on creating the sensation of vection. Comfort can be further improved if only a single screen is used, that follows the user's gaze into the virtual environment, tracking with some delay. This enables the user to allow their field of view to rest on areas that are not moving to help reduce the sensation of vection. Utility can be improved if parallax information is used to guide the camera field of view within the screens, as the user can then “look around” obstacles to see what they are trying to do in VR.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, configurations, user interface screens, data definitions, or process flows described herein are necessarily intended to limit the scope of the invention, unless such aspects are specifically included in the claims.

Any element expressed herein as a means for performing a specified function is intended to encompass any way of performing that function including, for example, a combination of elements that performs that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, various models or platforms can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions that may be employed to cause programmable equipment to execute the processes may be stored in any storage device, such as a computer system (non-volatile) memory. Furthermore, some of the processes may be programmed when the computer system is manufactured or via a computer-readable memory storage medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. Memory and/or storage components may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

A “computer,” “computer system,” “computing apparatus,” “component,” or “computer processor” may be, for example and without limitation, a processor, microcomputer, minicomputer, server, mainframe, laptop, personal data assistant (PDA), wireless e-mail device, smart phone, mobile phone, electronic tablet, cellular phone, pager, fax machine, scanner, or any other programmable device or computer apparatus configured to transmit, process, and/or receive data. Computer systems and computer-based devices disclosed herein may include memory and/or storage components for storing certain software applications used in obtaining, processing, and communicating information. It can be appreciated that such memory may be internal or external with respect to operation of the disclosed embodiments. In various embodiments, a “host,” “engine,” “loader,” “filter,” “platform,” or “component” may include various computers or computer systems, or may include a reasonable combination of software, firmware, and/or hardware. In certain embodiments, a “module” may include software, firmware, hardware, or any reasonable combination thereof.

In various embodiments of the present invention, a single component may be replaced by multiple components, and multiple components may be replaced by a single component, to perform a given function or functions. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it can be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language such as .NET or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86: examples of high-level languages include Ada, BASIC, C, C++, C#, COBOL, Fortran, Java, Lisp, Pascal, Object Pascal: and examples of scripting languages include Bourne script, JavaScript, Python, Ruby, PHP, and Perl. Various embodiments may be employed in a Lotus Notes environment, for example. Such software may be stored on any type of suitable computer-readable medium or media such as, for example, a magnetic or optical storage medium.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. Wireless communications described herein may be conducted with Wi-Fi and Bluetooth enabled networks and devices, among other types of suitable wireless communication protocols. The computer networks may also be embodied as one or more of the following types of networks: local area network (LAN): metropolitan area network (MAN): wide area network (WAN): virtual private network (VPN): storage area network (SAN): or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the wireless device to the network. The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs): remote bridges can be used to create a wide area network (WAN) link between LANs: and/or, wireless bridges can be used to connect LANs and/or to connect remote stations to LANs.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a processor or application specific processor.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. Discrete components and features may be readily separated from or combined with the features of any of the other several aspects without departing from the scope of the present disclosure. Any recited method can be carried out in the order of events recited or in any other order which is logically possible.

Unless specifically stated otherwise, it may be appreciated that terms such as “processing,” “computing.” “calculating,” “determining,” or the like, refer to the action and/or processes of a computer or computing system, or similar electronic computing device, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

Certain embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It can be appreciated that those skilled in the art can be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

Although various systems described herein may be embodied in software or code executed by hardware as discussed above, as an alternative the same may also be embodied in dedicated hardware or a combination of software/hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc.

The flow charts and methods described herein show the functionality and operation of various implementations. If embodied in software, each block, step, or action may represent a module, segment, or portion of code that comprises program instructions to implement the specified logical functions. The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical functions.

Reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment. The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as” or “for example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

In various embodiments of the present invention, different types of artificial intelligence tools and techniques can be incorporated and implemented. Search and optimization tools including search algorithms, mathematical optimization, and evolutionary computation methods can be used for intelligently searching through many possible solutions. For example, logical operations can involve searching for a path that leads from premises to conclusions, where each step is the application of an inference rule. Planning algorithms can search through trees of goals and subgoals, attempting to find a path to a target goal, in a process called means-ends analysis.

Heuristics can be used to prioritize choices in favor of those more likely to reach a goal and to do so in a shorter number of steps. In some search methodologies heuristics can also serve to eliminate some choices unlikely to lead to a goal. Heuristics can supply a computer system with a best estimate for the path on which the solution lies. Heuristics can limit the search for solutions into a smaller sample size, thereby increasing overall computer system processing efficiency.

Propositional logic can be used which involves truth functions such as “or” and “not” search terms, and first-order logic can add quantifiers and predicates, and can express facts about objects, their properties, and their relationships with each other. Fuzzy logic assigns a degree of truth (e.g., between 0 and 1) to vague statements which may be too linguistically imprecise to be completely true or false. Default logics, non-monotonic logics and circumscription are forms of logic designed to help with default reasoning and the qualification problem. Several extensions of logic can be used to address specific domains of knowledge, such as description logics, situation calculus, event calculus and fluent calculus (for representing events and time), causal calculus, belief calculus (belief revision): and modal logics. Logic for modeling contradictory or inconsistent statements arising in multi-agent systems can also be used, such as paraconsistent logics.

Probabilistic methods can be applied for uncertain reasoning, such as Bayesian networks, hidden Markov models, Kalman filters, particle filters, decision theory, and utility theory. These tools and techniques help the system execute algorithms with incomplete or uncertain information. Bayesian networks are tools that can be used for various problems: reasoning (using the Bayesian inference algorithm), learning (using the expectation-maximization algorithm), planning (using decision networks), and perception (using dynamic Bayesian networks). Probabilistic algorithms can be used for filtering, prediction, smoothing and finding explanations for streams of data, helping perception systems to analyze processes that occur over time (e.g., hidden Markov models or Kalman filters). Artificial intelligence can use the concept of utility as a measure of how valuable something is to an intelligent agent. Mathematical tools can analyze how an agent can make choices and plan, using decision theory, decision analysis, and information value theory. These tools include models such as Markov decision processes, dynamic decision networks, game theory and mechanism design.

The artificial intelligence techniques applied to embodiments of the invention may leverage classifiers and controllers. Classifiers are functions that use pattern matching to determine a closest match. They can be tuned according to examples known as observations or patterns. In supervised learning, each pattern belongs to a certain predefined class which represents a decision to be made. All of the observations combined with their class labels are known as a data set. When a new observation is received, that observation is classified based on previous experience. A classifier can be trained in various ways: there are many statistical and machine learning approaches. The decision tree is one kind of symbolic machine learning algorithm. The naive Bayes classifier is one kind of classifier useful for its scalability, in particular. Neural networks can also be used for classification. Classifier performance depends in part on the characteristics of the data to be classified, such as the data set size, distribution of samples across classes, dimensionality, and the level of noise. Model-based classifiers perform optimally when the assumed model is an optimized fit for the actual data. Otherwise, if no matching model is available, and if accuracy (rather than speed or scalability) is a primary concern, then discriminative classifiers (e.g., SVM) can be used to enhance accuracy.

A neural network is an interconnected group of nodes which can be used in connection with various embodiments of the invention, such as execution of various methods, processes, or algorithms disclosed herein. Each neuron of the neural network can accept inputs from other neurons, each of which when activated casts a weighted vote for or against whether the first neuron should activate. Learning achieved by the network involves using an algorithm to adjust these weights based on the training data. For example, one algorithm increases the weight between two connected neurons when the activation of one triggers the successful activation of another. Neurons have a continuous spectrum of activation, and neurons can process inputs in a non-linear way rather than weighing straightforward votes. Neural networks can model complex relationships between inputs and outputs or find patterns in data. They can learn continuous functions and even digital logical operations. Neural networks can be viewed as a type of mathematical optimization which performs a gradient descent on a multi-dimensional topology that was created by training the network. Another type of algorithm is a backpropagation algorithm. Other examples of learning techniques for neural networks include Hebbian learning, group method of data handling (GMDH), or competitive learning. The main categories of networks are acyclic or feedforward neural networks (where the signal passes in only one direction), and recurrent neural networks (which allow feedback and short-term memories of previous input events). Examples of feedforward networks include perceptrons, multi-layer perceptrons, and radial basis networks.

Deep learning techniques applied to various embodiments of the invention can use several layers of neurons between the network's inputs and outputs. The multiple layers can progressively extract higher-level features from the raw input. For example, in image processing, lower layers may identify edges, while higher layers may identify the concepts relevant to a human such as digits or letters or faces. Deep learning may involve convolutional neural networks for many or all of its layers. In a convolutional layer, each neuron receives input from only a restricted area of the previous layer called the neuron's receptive field. This can substantially reduce the number of weighted connections between neurons. In a recurrent neural network, the signal can propagate through a layer more than once. A recurrent neural network (RNN) is another example of a deep learning technique which can be trained by gradient descent, for example.

While various embodiments of the invention have been described herein, it should be apparent, however, that various modifications, alterations, and adaptations to those embodiments may occur to persons skilled in the art with the attainment of some or all of the advantages of the present invention. The disclosed embodiments are therefore intended to include all such modifications, alterations, and adaptations without departing from the scope and spirit of the present invention as described and claimed herein.

What is claimed is:

1. A computer-implemented apparatus comprising:
a virtual reality environment module programmed with computer-executable instructions for facilitating training of a trainee with using at least one piece of industrial equipment.
